(19) United States
(12) Patent Application Publication
(10) Pub. No.: US 2002/0094224 A1
(43) Pub. Date: Jul. 18, 2002

(54) Dual nail polish bottle

(76) Inventor: Constance Kaufman, New York, NY (US)

Correspondence Address: ALFRED M. WALKER, PATENT ATTORNEY, 225 Old Country Road, Melville, NY, 11747-2712, US

(21) Appl. No.: 10/093,976

(22) Filed: Mar. 7, 2002

Related U.S. Application Data
(63) Continuation-in-part of application No. 29/145,577, filed on Jul. 25, 2001, now Pat. No. D455349.
(63) Continuation-in-part of application No. 29/122,525, filed on Apr. 28, 2000, now Pat. No. D449224.

(51) Int. Cl. B05C 1/00

(52) U.S. Cl. 401/17; 401/16

(57) ABSTRACT

An upright nail polish bottle includes a pair of inseparably adjoined compartments joined by a permanent common wall for different colored nail polishes. The dual nail polish bottle has a pair of closable brush handle caps with separate fluid accommodating brushes for the two different colored polishes in the inseparably joined compartments. In a preferred embodiment, one compartment is of a lesser height than the other compartment. The comparable brush applicator is also proportionately smaller than the other brush applicator. In such a configuration, the common wall permanently separating the pair of compartments from each other is not parallel to the side edges of the dual bottle, but intersects at least one side edge obliquely, either in a curved and straight slanted direction.

### FIELD OF THE INVENTION

The present invention relates to a dual nail polish bottle. More particularly, the present invention relates to an improved nail polish bottle that has two separate compartments that hold two different color nail polishes in one bottle.

### BACKGROUND OF THE INVENTION

The wide variety of colors of nail polish often requires a user to carry multiple bottles.

In addition, the preferred covering of an opaque colored nail polish with an outer clear coating necessitates the carrying of a separate bottle for the clear coating fluid, such as butyl acetate, toluene or alcohol. U.S. Pat. No. 5,130,125 describes such top coatings for nail polish.

Among typical components of nail polish fluids include titanium, butyl acetate, stearalkonium necorite, nitrocellulose, polyester resins, polyethylene, diacetone, dibutyl phthalate and/or other phthalates, camphor, DNC colorings, barium lake, calcium lake, aluminum lake, mica, bismuth, ferrocyanide and guanine.

Furthermore, the necessity of carrying a dual nail polish bottle is further compounded by the fact it is not uncommon for the polish to chip or crack after it is applied to one's nails and necessitate repair or reapplication of the polish. Therefore, there is a need for a nail polish bottle having dual compartments containing two different colors and two different kinds of polish, to allow one to repair and adhere old polish on ones nails without having to carry two or more bottles of polish while traveling.

A number of solutions have been proposed to aforementioned problems. These solutions, while being satisfactory for certain uses, have no similar use to the presented dual nail polish bottle. A combination cosmetic applicator device, is taught in U.S. Pat. No. 5,655,554 to Goldberg. However, the applicator of Goldberg '554 accommodates nail polish, polish remover and cotton in an elongated tube with separate axially aligned, threadably connected compartments. Furthermore it dose not supply a side by side compartment in a upright bottle that holds two different types and/or colors of nail polish. In fact, the compartments in Goldberg '184 re designed to be separated from each other. Moreover, the centrally located nail polish remover compartment of Goldberg '184 cannot be accessed without removing the adjacent end compartment from the container.

Furthermore, U.S. Pat. No. 2,691,184 of Miller, describes a multiple compartment device with separate compartments for lipstick and for lipstick remover. This particular device of Miller '185 however, is not presented in an upright bottle with two separate components. Furthermore it is unable to hold two different colored nail polishes, side by side, in the same bottle.

Among dual bottles includes U.S. Design Pat. No. Des. 220,864 of Weckman. However, Weckman '864 describes only adjacent bottles with caps, and does not teach the use of adjacent compartments, each having a respective nail polish brush extending within each compartment.

U.S. Design Pat. No. Des. 280,599 of Green describes two mirror image compartments in side-by side relationship in a single bottle. Green '599 also fails to teach two adjacent compartments, each having a respective nail polish brush extending within each compartment.

U.S. Design Pat. No. Des 210,324 of Rapaz discloses a flask with a smaller compartment having a horizontally oriented cap above a larger compartment with a vertically oriented cap. Rapaz '324 fails to teach a pair of adjacent compartments in a single bottle with a pair of nail polish brushes extending with the two compartments.

In addition, U.S. Pat. No. 5,897,262 of Bratby-Carey discloses a dual compartment container with axially aligned compartments for nail polish and nail polish remover. Bratby-Carey '262 also discloses a cotton dab applicator within the container and an emery board attached to the container.

However, these prior art patents fails to teach a dual nail polish bottle with two adjacent compartments separated by a common wall, wherein the compartments respectively carry different colored nail polish, each having a respective nail polish brush extending within each compartment.

### OBJECTS OF THE INVENTION

It is therefore an object of the present invention to provide an upright dual nail polish bottle having two adjacent inseparable compartments, for different colored nail polishes, or a colored nail polish and a clear coat, wherein each compartment has a respective cap with a nail polish applicator brush extending into each respective compartment of the upright bottle.

It is also an object of the present invention to allow consumers the choice of more than one color in one dual nail polish bottle.

### SUMMARY OF THE INVENTION

In keeping with these and other objects the present invention, which will become more apparent from the following detailed description of the drawings includes an upright nail polish bottle with inseparable adjoining compartments joined by a permanent connecting means located therein.

Adjoining the common wall on one side is a compartment for one colored nail polish and adjoining the wall on an opposite side is an adjacent compartment that hold a different colored or clear nail polish.

The dual nail polish bottle has a pair of closable brush handle caps with separate fluid accommodating brushes for the two different colored polishes in the inseparably joined compartments. An optional over cap covers both brush caps which each have nail polish brushes that are located in each respective compartment of the bottle to apply each of the two polishes to the user's nail. Each compartment is connected to the permanent wall comprising the connecting means. The optional over cap is placed on top of the bottle for a finished presentation, instead of the two protruding brush caps.

### BRIEF DESCRIPTION OF THE DRAWINGS

The present invention can best be described in conjunction with the accompanying drawings, wherein like reference numbers refer to corresponding parts throughout the several views of preferred embodiments of the invention and wherein:

FIG. 1 is a perspective view of a dual bottle, showing a transparent body having respective nail polish and related brushes in separate respective hollow fluid accommodating chambers therein, wherein the said brushes have respective sealing caps extending above the transparent body;

FIG. 2 is a front elevation view thereof;

FIG. 3 is a right side elevation view thereof;

FIG. 4 is a top plan view thereof;

FIG. 5 is a perspective view of an alternate configuration for a dual bottle with an opaque body having an over cap cover thereon, said over cap cover also being optional for the transparent body design shown in FIGS. I through 4 herein;

FIG. 6 is a top plan view thereof;

FIG. 7 is a bottom view thereof;

FIG. 8 is a front elevation view thereof;

FIG. 9 is a right side elevation view thereof; and,

FIG. 10 is a left side elevation view thereof.

### DETAILED DESCRIPTION OF THE INVENTION

The dual nail polish bottle of the present invention includes a portable upright having a pair of compartments containing two different colored nail polishes. The dual nail polish bottle with two separate compartments is both able to hold two different types of nail polish and two separate brushes in one bottle.

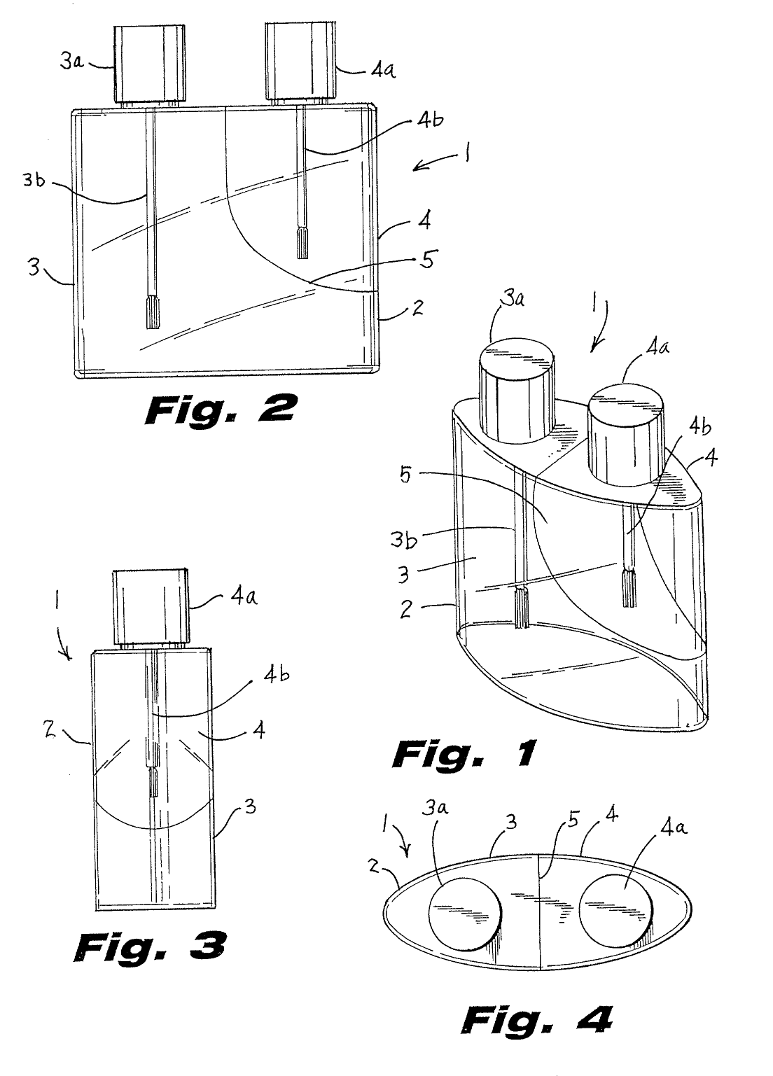

FIGS. 1-4 show dual bottle 1 having a transparent hollow body 2 having respective nail polish compartments 3 and 4 in a side by side relationship, with respective brush applicators 3b, and 4b therein. Brush applicators 3b, 4b are made of stem portions 3c, 4c and brushes 3d, 4d. Brush applicators 3b, 4b apply nail polish fluid from the respective separate respective hollow fluid accommodating compartments 3, 4 of dual nail polish bottle 1.

To manually assist the user, brush applicators 3b, 4b have respective sealing cap handles 3a, 4a extending above the hollow body 2. Each sealing cap handle 3a, 4a, is connected to a respective nail polish brush applicator stem portions 3c or 4c, each having brushes 3d, 4d at distal ends thereof, to apply different colored nail polish, or a colored nail polish and a clear coating polish, from the respective hollow compartments 3 and 4.

A permanent wall 5 isolates the two compartments from each other in a permanent fixed relationship.

Preferably, the width of dual bottle 1 is equal to or greater than the height of dual bottle 1 to provide stability when standing upright, such as with one or both of the compartments 3 or 4 open, exposing the nail polish fluids therein to spillage if the dual bottle 1 is tipped over.

Preferably, also each nail brush applicator 3b or 4b is less than two inches in length, to allow for accurate manual application of the nail polish upon the nail. Moreover, the height of each compartment must be only slightly higher than the length of each brush 3b or 4b, to allow the respective distal ends of each brush 3d or 4d to reach the fluid contents of each respective compartment 3a or 4a.

In a preferred embodiment, where one compartment 4 is of a lesser height than the other compartment 3, the comparable brush applicator 4b is also proportionately smaller than the other brush applicator 3b, as is the fluid holding volume capacity of smaller compartment 4, when compared to the fluid holding capacity of larger compartment 3 of bottle 1. In such a configuration with smaller compartment 4 being smaller than larger compartment 3, common wall 5 permanently separating compartments 3 and 4 from each other is not parallel to the side edges of bottle 1, but intersects at least one side edge obliquely either in a curved and straight slanted direction.

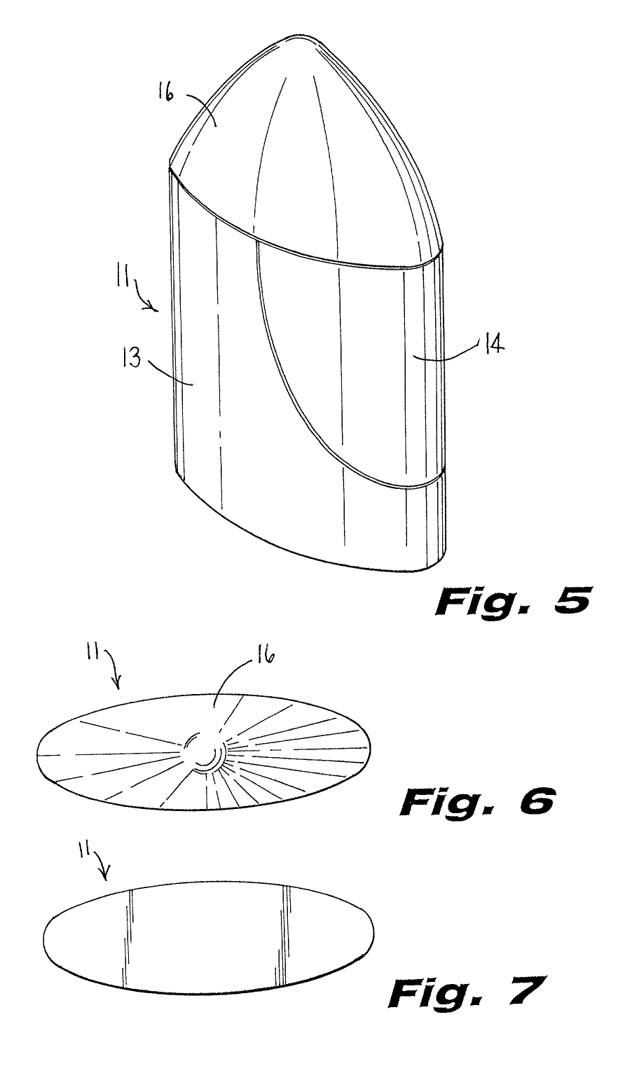

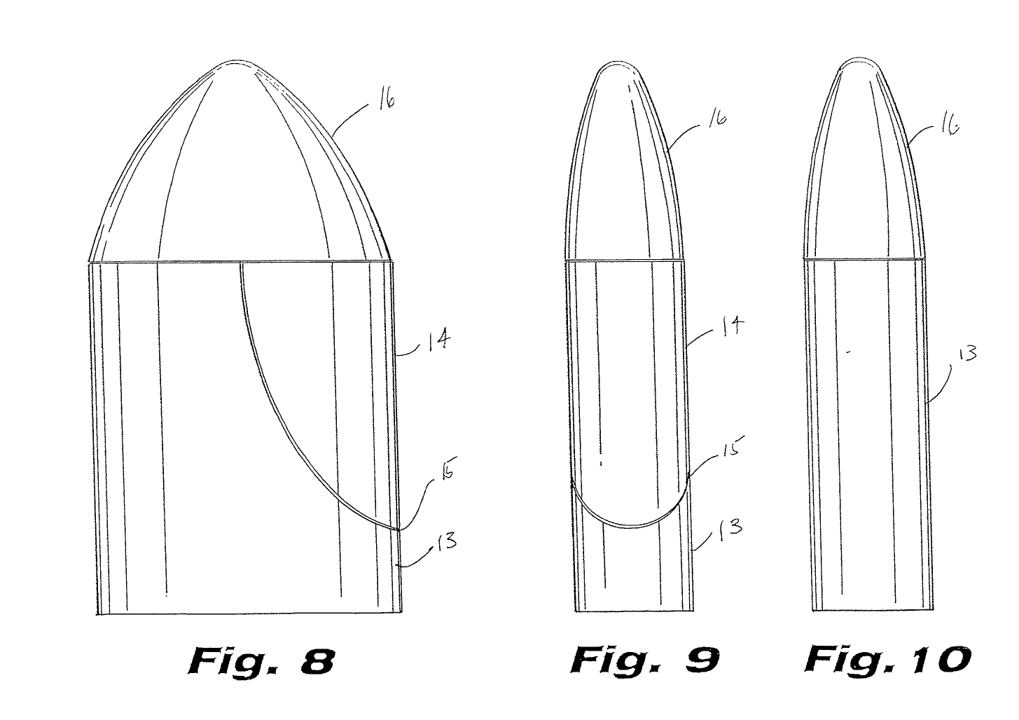

FIGS. 5-10 show an alternate configuration for a dual bottle 11 with an opaque body 12 having an over cap cover 16 thereon. This over cap cover 16 also can be optional for the transparent body design shown in FIGS. 1 through 4 herein. Opaque body 12 includes hollow compartments 13, 14 having brushes (not shown) attached to brush caps (not shown). Hollow compartments 13, 14 are joined permanently by common wall 15 extending therebetween. The over cap cover 16 covers the top of dual bottle 11.

It is noted that other changes to embodiments of the present invention may be made to the configuration and function of the present invention without departing from the scope of the invention, as noted in the appended Claims.

I claim:

1. An upright dual nail polish bottle comprising:
a hollow body having a pair of adjacent inseparable compartments joined by a common wall in a side by side relationship,
said pair of compartment holding one of a pair of different colored nail polishes and a pair of a colored nail polish and a clear coat,
each said compartment having a respective cap handle with a respective nail polish brush applicator extending therefrom into each said respective compartment of the upright bottle, each said respective cap handle alternately sealing and unsealing each said respective compartment having said nail polish fluid therein, and,
each said nail polish brush applicator comprising a stem portion extending into each respective compartment and a respective fluid accommodating brush at respective distal ends thereof.

2. The dual nail polish bottle as in claim 1 further comprising an over cap covering both said cap handles.

3. The dual nail polish bottle as in claim 1 wherein a predetermined width of said hollow body of said dual nail polish bottle is at least equal to than a predetermined height of said dual bottle.

4. The dual nail polish bottle as in claim 1 wherein each brush applicator is less than two inches in length.

5. The dual nail polish bottle as in claim 1 wherein each respective compartment has a predetermined height being approximately equal to a predetermined length of each said brush applicator.

6. The dual nail polish bottle as in claim 1 wherein said hollow body is transparent.

7. The dual nail polish bottle as in claim 1 wherein said hollow body is opaque.

8. The dual nail polish bottle as in claim 1 wherein one first compartment of said pair of compartments has a predetermined height being less than a predetermined height of a second compartment of said pair of compartments,
wherein further a respective first brush applicator extending into said first compartment is proportionately smaller than a respective second brush applicator extending into said second compartment, and,
said first compartment having a predetermined smaller fluid holding volume capacity than a predetermined larger fluid holding volume capacity of said second larger compartment.

9. The dual nail polish bottle as in claim 1 wherein said common wall permanently separating said smaller and larger compartments from each other is not parallel to respective side edges of said hollow body of said dual nail polish bottle, said common wall intersecting at least one side edge of said hollow body of said dual nail polish bottle obliquely.

10. The dual nail polish bottle as in claim 1 wherein said wall obliquely intersects said hollow body of said dual nail polish bottle in a curved direction.

11. The dual nail polish bottle as in claim 1 wherein said wall obliquely intersects said hollow body of said dual nail polish bottle in a straight slanted direction.

12. An upright dual nail polish bottle comprising:
a hollow body having a pair of adjacent inseparable compartments joined by a common wall in a side by side relationship,
said pair of compartment holding one of a pair of different colored nail polishes and a pair of a colored nail polish and a clear coat,
each said compartment having a respective cap handle with a respective nail polish brush applicator extending therefrom into each said respective compartment of the upright bottle, each said respective cap handle alternately sealing and unsealing each said respective compartment having said nail polish fluid therein,
each said nail polish brush applicator comprising a stem portion extending into each respective compartment and a respective fluid accommodating brush at respective distal ends thereof,
wherein a predetermined width of said hollow body of said dual nail polish bottle is at least equal to than a predetermined height of said dual bottle,
wherein each brush applicator is less than two inches in length,
wherein one first compartment of said pair of compartments has a predetermined height being less than a predetermined height of a second compartment of said pair of compartments,
wherein further a respective first brush applicator extending into said first compartment is proportionately smaller than a respective second brush applicator extending into said second compartment,
said first compartment having a predetermined smaller fluid holding volume capacity than a predetermined larger fluid holding volume capacity of said second larger compartment.
wherein said common wall permanently separating said smaller and larger compartments from each other is not parallel to respective side edges of said hollow body of said dual nail polish bottle, and,
said common wall intersecting at least one side edge of said hollow body of said dual nail polish bottle obliquely.

13. The dual nail polish bottle as in claim 13 wherein said hollow body is transparent.

14. The dual nail polish bottle as in claim 13 wherein said hollow body is opaque.

15. The dual nail polish bottle as in claim 13 wherein said common wall obliquely intersects said hollow body of said dual nail polish bottle in a curved direction.

16. The dual nail polish bottle as in claim 15 wherein said common wall obliquely intersects said hollow body of said dual nail polish bottle in a straight slanted direction.

17. The dual nail polish bottle as in claim 15 further comprising an over cap covering both said cap handles.
